(19) United States
(12) Patent Application Publication
(10) Pub. No.: US 2008/0246769 A1
(43) Pub. Date: Oct. 9, 2008

(54) Method of Stable Incremental Layout For a Hierarchical Graph Representation

(76) Inventors: Denis S. Milov, Kirishi (RU); Egor A. Kazachkov, Nizhny Novgorod (RU)

Correspondence Address: INTEL CORPORATION;c/o INTELLEVATE, LLC, P.O. BOX 52050, MINNEAPOLIS, MN, 55402, US

(21) Appl. No.: 10/575,670

(22) PCT Filed: Feb. 21, 2005
(86) PCT No.: PCT/RU05/00075

§ 371 Date: Apr. 10, 2006

(51) Int. Cl. G06F 17/50; G06T 11/20

(52) U.S. Cl. 345/440

(57) ABSTRACT

Embodiments of the present invention generate a stable incremental layout of a hierarchical graph by determining a level of the layout for each new node of the graph using information about hidden nodes of the graph, determining positions of nodes on levels of the layout using information about hidden nodes of the graph, and determining coordinates of new nodes in the layout without using information about hidden nodes.

### BACKGROUND

1. Field

The present invention relates generally to automatic graph drawing processes for data visualization and, more specifically, to minimizing visual layout changes during graph structure modifications in hierarchical directed graphs.

2. Description

Many fields in computer science, such as software engineering, electronic circuit design, and database design, have found it useful to represent data as graphs, with vertices (or nodes) denoting elements and edges denoting relations between them. These graphs are normally generated by software tools based on information in a computer system. In software engineering, the architecture of a large software system can be visualized as a directed graph with vertices representing modules and edges denoting various use relations between them. These systems are often hierarchical in nature and their drawings reflect this.

A graph representation is hierarchical if graph nodes are placed on ordered levels. See FIG. 1, for example, where nodes on the left side of the diagram are considered to be at a lower level than nodes on the right side of the diagram. Such a representation is widely used for visualization of procedure call graphs, flow charts, and many other diagrams in software design tools. Node levels are determined by the following rule: if there exists an edge from node A to node B, then node B should be placed on any level of the graph after the level with node A. Therefore, edges should go from lower levels to higher levels. Note that it is not always possible to distribute nodes on levels in this way. In that case, one must turn back some edges. Such edges are called “back edges”. For example, edge “3-1” on FIG. 1 is a back edge. Because inclusion of back edges has a negative effect on a hierarchical representation, a typical mandatory quality criterion for a graph layout is to minimize the number of back, edges.

Usually some quality criteria are used to determine if a given layout is desirable. A typical prior art layout of a graph works in such a way that if one changes the graph a small amount and applies the quality criteria when generating the layout, then the new layout can be very different from the previous one. However, if the layout of the permanent graph part is forced to remain exactly as is, one sometimes cannot conform the new layout of the graph to the quality criteria.

Most existing graph drawing algorithms are not incrementally stable. They usually apply batch techniques to optimize objectives such as reducing total edge crossings or edge length. A small change in the input set, even just its ordering, may yield unpredictable, unstable changes between successive layouts. This may occur even if a previous layout is taken as a starting configuration. The results can be confusing when viewing a sequence of layouts. Instead, it is preferable, in order to avoid user misunderstandings, to keep the layout in compliance with quality criteria but to also minimize radical changes to the layout based on small changes to the graph.

### BRIEF DESCRIPTION OF THE DRAWINGS

The features and advantages of the present invention will become apparent from the following detailed description of the present invention in which:

FIG. 1 is a diagram of a hierarchical graph with two levels (prior art);

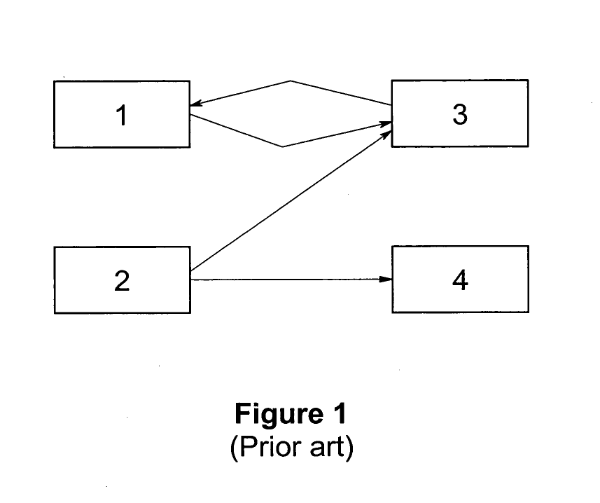

FIG. 2 is a diagram of an initial graph layout;

FIG. 3 is a diagram of a full layout after adding a node;

FIG. 4 is a diagram of another full layout;

FIG. 5 is a diagram of a stable incremental full layout;

FIG. 6 is a flow diagram of a stable incremental hierarchical layout process according to an embodiment of the present invention;

FIG. 7 is a diagram of a first example layout according to a prior art method;

FIG. 8 is a diagram of a second example layout according to a prior art method;

FIG. 9 is a diagram of a third example layout according to an embodiment of the present invention; and

FIG. 10 is a diagram of a fourth example layout according to an embodiment of the present invention.

### DETAILED DESCRIPTION

An embodiment of the present invention comprises a stable incremental layout process for minimization of visual graph changes during hierarchical graph structure modifications. In at least one embodiment, the present invention comprises an incremental layout method that guarantees preservation of the layout (to some extent) for a permanent graph portion, while generating an acceptable layout for a changing graph portion. Hierarchical representation specific features (such as dividing nodes by levels) may be used in order to improve the stability of the layouts and ensure conformance to quality criteria in a series of graph changes. In at least one embodiment, the graphs are directed acyclic graphs (DAGs).

To avoid the problems of prior art processes, embodiments of the present invention allow only one type of layout change: dividing a graph into two parts and moving the parts apart in the case when a new level needs to be inserted between the existing levels. In both parts of the graph, existing nodes and edges do not change their relative positions. Thus, embodiments of the present invention restrict the possible layout modifications to improve the stability of the layout through a series of small graph changes. In addition, information about hidden nodes (if any) may be used in order to reduce the number of cases when insertion of new levels into the graph is required.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

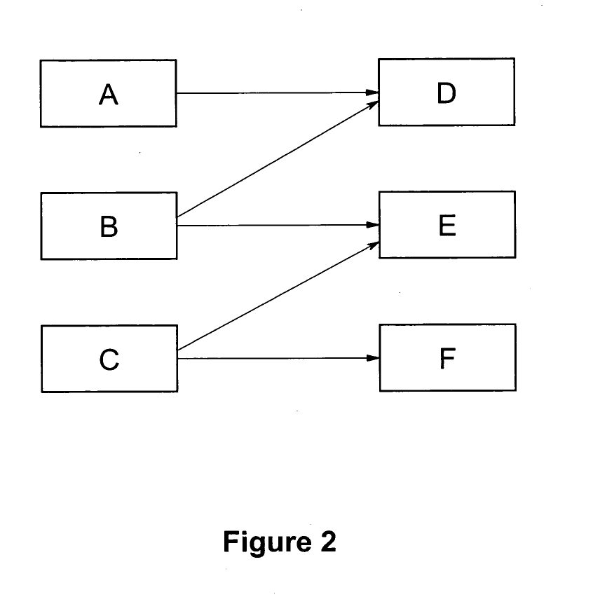

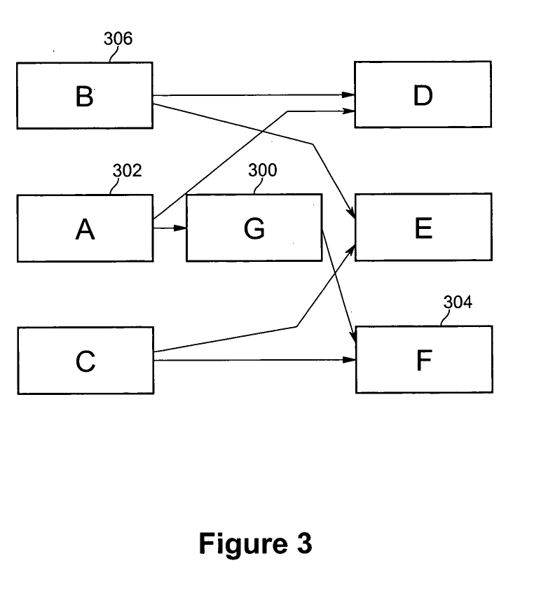

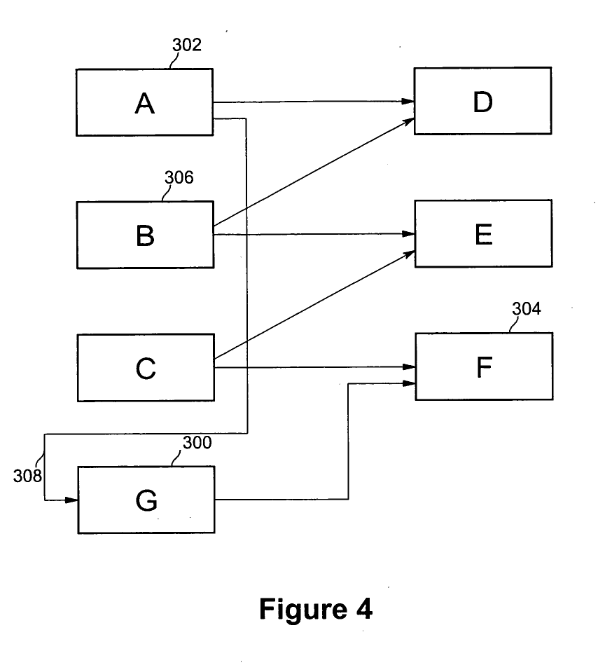

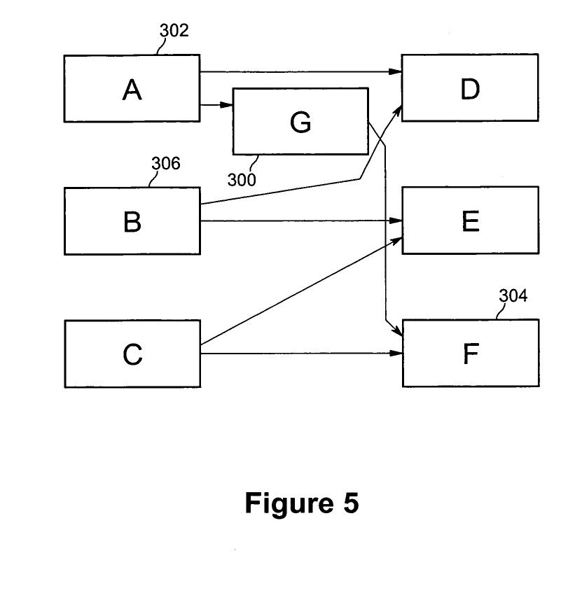

Consider the example graphs of FIGS. 2 through 5. In these examples, let nodes be placed on graph levels which are ordered from left to right, so edges between nodes should go from left to right. One quality criterion which may be used during graph layout processing is to minimize the number of edge crossings. FIG. 2 shows an example graph with an initial layout complying with the above criteria. Next, an incremental change may be made in the graph structure by adding or revealing a new node G 300, with edges from node A 302 to node G, and from node G 300 to node F 304. FIG. 3 shows the example graph layout after the change has been made, when applying the criteria to generate a new layout. The new layout conforms to the criteria, but nodes A 302 and B 306 change their mutual positions in the layout. This may be undesirable from the standpoint of the user of the graph layout. In another example as shown in FIG. 4, a substantial part of the graph may be kept the same as in the initial layout, but placement of the new node G results in a graph layout less conforming to the desired criteria than the layout of FIG. 3. The layout of FIG. 4 is less desirable because now there are more edge crossings (four instead of two), and a back edge has been introduced from node A 302 to node G 300. In FIG. 5, the stable incremental layout method of an embodiment of the present invention is used. Existing nodes keep their order and mutual position in the graph layout and there are no back edges. In comparison with FIG. 4, there are now only three edge crossings and no back edges. In comparison with FIG. 3, there is one more edge crossing, but existing nodes on the first level (e.g., nodes A, B, and C) keep the same order. Thus, this layout is preferable to the other layouts in this simple example.

In one embodiment, an initial layout for a graph may be generated by using a well known algorithm, such as the process described in “Methods for Visual Understanding of Hierarchical Systems” by K. Sugiyama, S. Tagawa, and M. Toda, published in IEEE Trans. Syst. Man Cybern., SMC-11(2):109-125, 1981, for example, or other similar heuristics. In other embodiments, other algorithms for determining the initial layout of the graph may be used. This process includes three steps. First, node levels are determined for each node in the graph. In this step, a “minimum of back edges” criterion is used. Second, the node positions on each level are determined. In this step, a “minimum of edge crossings” criterion is used. Third, exact node coordinates are determined. In this step, different criteria may be used (such as, layout compactness or a centering strategy).

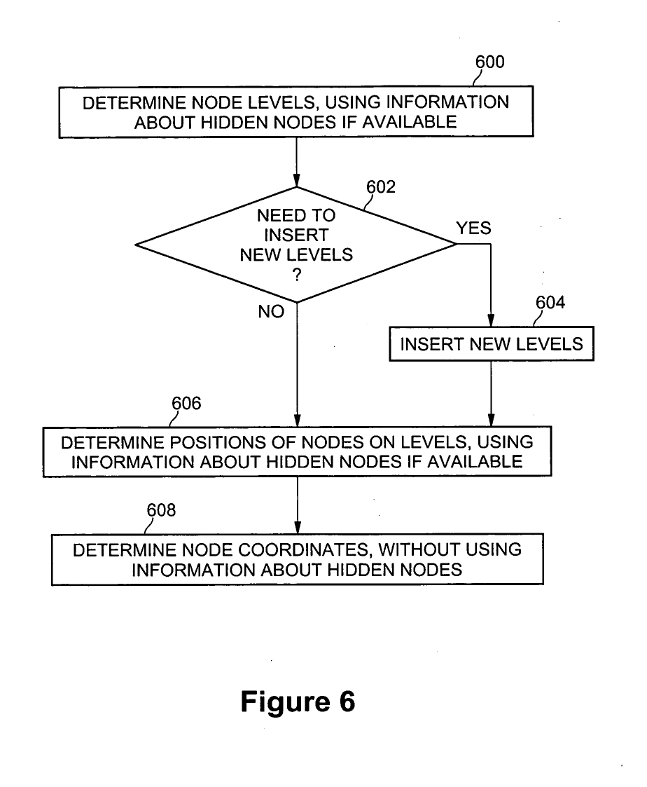

After the initial layout has been generated, embodiments of the present invention may be used to provide stable incremental changes to the layout as a result of graph modifications. FIG. 6 is a flow diagram illustrating implementing incremental layout changes according to an embodiment of the present invention. First, at block 600, new node levels of the layout may be determined, using information about hidden nodes of the graph, if available.

Hidden nodes often appear in applications which work with large graphs because it doesn't make sense in many instances to show the enitre graph to user. Large graphs (perhaps with hundreds or thousands of nodes) are hard to understand and navigate, and the user is typically interested only in some small part of the graph. In embodiments of the present invention, an entire large graph is known upon system initialization, and only a small part of the graph may be shown to the user. The user can then instruct the application to reveal hidden nodes as necessary.

Two approaches are typically used in graph layout when some nodes can be hidden. The first approach ignores hidden nodes completely during layout. The second approach uses hidden nodes as normal during layout (later they are just not displayed). For example, in the known prior art system called “DaVinci” the second approach is used by default and the user could choose manually the first approach. The DaVinci system is available on the Internet at (http://www-informatik-uni-bremen-de/˜davinci/old/docs/reference/api/api menu cmd.html) (with “.” replaced as “−” to avoid a live link).

By taking hidden nodes into account, a better and more stable result in the layout may be achieved.

If some nodes should be placed on levels between the existing levels (block 602), then new levels may be inserted (block 604), or hidden levels may be shown. The levels of existing nodes are not changed. Next, at block 606, the position of new nodes on each level of the layout may be determined, using information about hidden nodes, if available. New nodes may be placed between old nodes if and only if there is free space for them. The positions of existing nodes on a level are not changed, and the same interval or space is kept between them. Finally, at block 608, the exact coordinates of new nodes on each level may be determined, without using information about hidden nodes. This allows the process to avoid empty spaces reserved for hidden nodes, makes the graph layout more compact (and therefore more clear and understandable for the user), and improves overall graph performance.

Table I below illustrates example pseudo-code for implementing an embodiment of the present invention. In at least one embodiment, two layout functions may be used. The first layout function is for the initial layout only. This function is similar to known methods, except that in the first layout function, hidden and visible nodes are considered differently. Further, the first layout function uses information about hidden nodes to determine levels and positions, but not for determining node coordinates. The second layout function may be used whenever the graph has changed and the user requests a layout of the changed part of the graph. The second layout function inserts new levels for new nodes when needed. If there are no new levels, existing nodes keep the same coordinates. When new levels are inserted, existing levels are kept the same (i.e., they don't change their relative positions). Additionally, information about hidden nodes is used only to determine levels and node positions, but not to determine node coordinates.

TABLE I

© 2004 Intel Corporation
bool layout_was_done = false;
make_layout( )
{

if (layout_was_done)

do_initial_layout( );
layout_was_done = true;

else

do_incremental_layout( );

}
do_initial_layout( )
{

determine_node_levels( );
//consider hidden nodes as normal
for_each(level)
{

determine_mutual_nodes_positions(level);
//consider hidden nodes as normal

}
for_each(level)
{

determine_nodes_coordinates(level);
// exclude hidden nodes

}

}
do_incremental_layout( )
{

for_each(new node)
{

determine_node_level(new_node);
// also determines if new level is needed or not.
if (new_level_needed)
{

insert_new_level( );
recalculate_coords_after_new_level( );

}

}
for_each(level)

determine_new_nodes_position( );
// consider hidden nodes as normal

for_each(level)

determine_new_nodes_coordinates( );
// exclude hidden nodes

}

The disclosed stable incremental layout process for hierarchical graphs has several desirable properties. The process keeps the layout stable through a series of small graph changes while simultaneously following the layout quality criteria. The only allowed layout change guarantees that after the change: 1) already placed nodes will be on the same levels; 2) already placed nodes and edges will be in the same order within a specific level of the graph; 3) already placed nodes and edges within one level will have the same interval or space between them; and 4) nodes placed along the line perpendicular to levels will be placed along the same line (e.g., if levels are vertical, as in the example graphs herein, then nodes placed along one horizontal line will be on the same horizontal line after the change). With the present invention, all steps of the method are extendible. In other embodiments, different quality criteria may be used.

Embodiments of the present invention allow for keeping the layout in compliance with the quality criteria (such as a minimum of edge crossings, for example), and preserving the visual stability of the layout at the same time. Unlike the prior art, embodiments of the present invention guarantee selected graph properties for already placed nodes and edges. Embodiments also may be used with different quality criteria and different algorithms for initial placement of nodes and edges. Finally, embodiments ensure that the layout is compliant with the quality criteria by using information about hidden nodes.

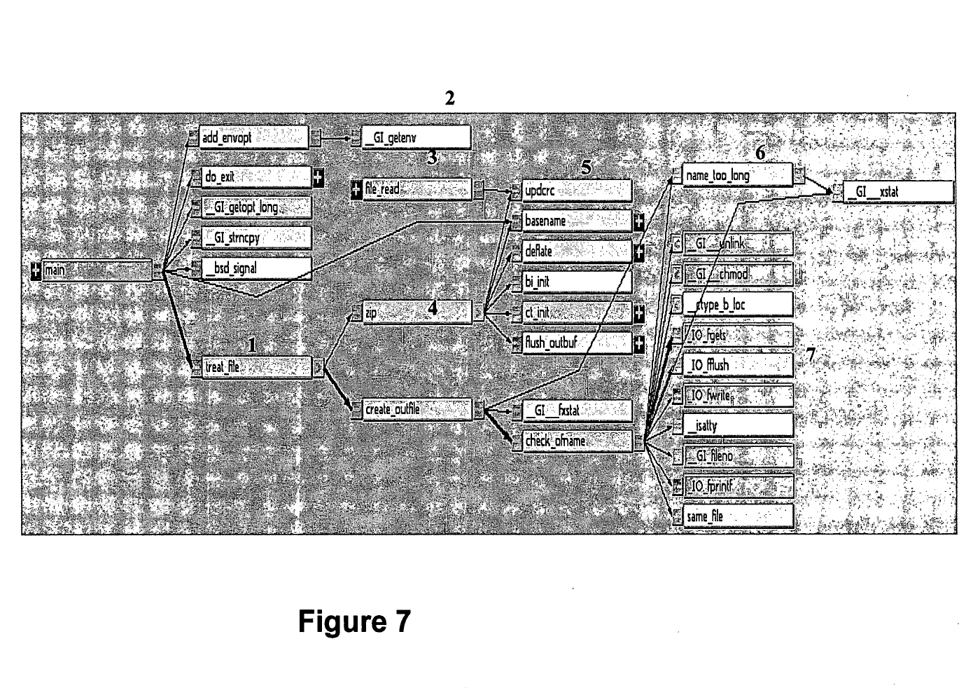

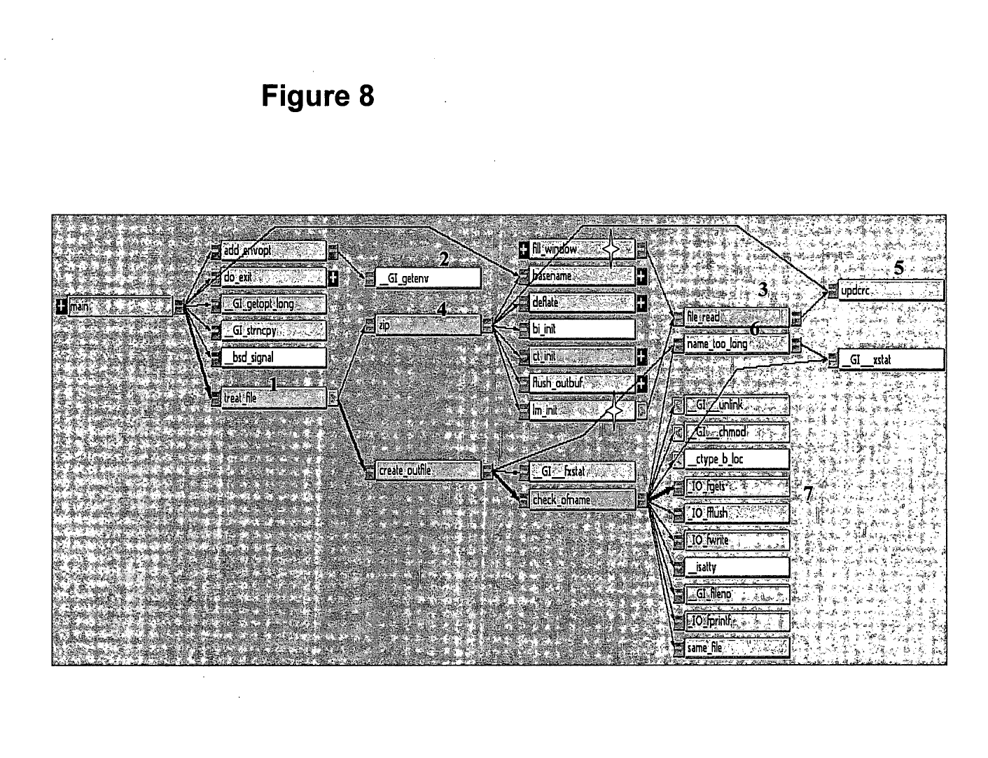

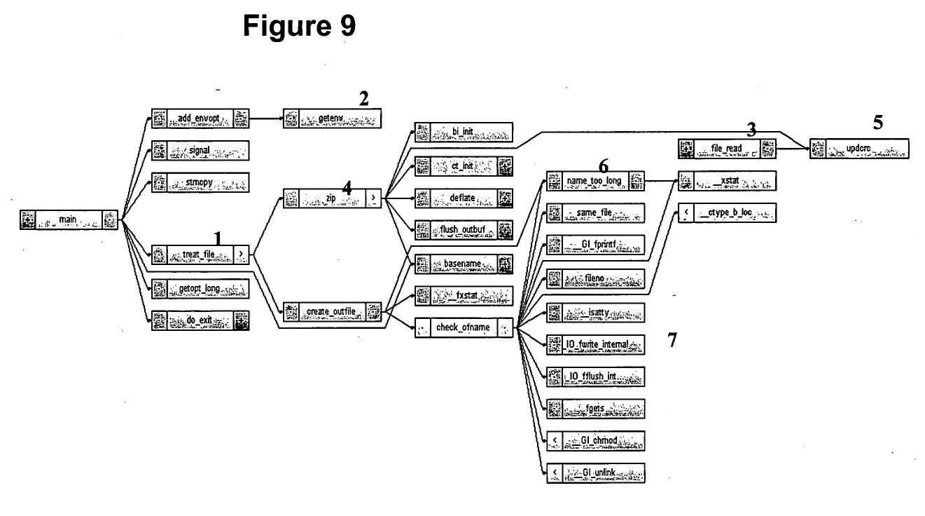

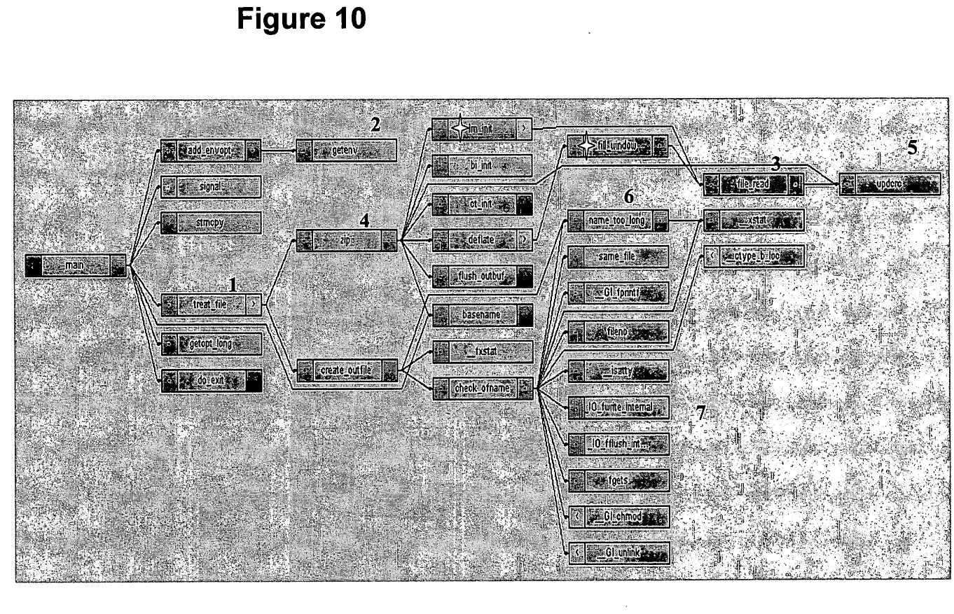

FIGS. 7 through 10 are examples of call graphs. FIG. 7 shows a call graph with a layout made by a prior art process, before revealing the hidden parent nodes of a selected node (the node numbered 3 in this example). FIG. 9 shows a call graph with a layout made by the stable incremental layout process of embodiments of the present invention, also before revealing hidden parent nodes of a selected node (node number 3). The layouts are different for at least the reason that embodiments of the present invention use information about hidden nodes in determining the layout. FIG. 8 shows the layout of FIG. 7 after revealing the hidden nodes (fill_window, and lm_init) using the prior art process. FIG. 10 shows the layout of FIG. 9 after revealing hidden nodes using an embodiment of the present invention. The layouts were made in an incremental mode. The change in the graph causes two new nodes to appear in the layout. New nodes in FIGS. 8 and 10 are marked by stars (i.e., the formerly hidden nodes fill_window and lm_init).

Nodes which change their positions as a result of graph changes are numbered in the figures. For example, in FIG. 8 (generated by a prior art process) two nodes have changed levels (numbers 3 and 5), and some nodes have been moved within their levels (nodes 1 and 4 shifted up and nodes 2, 6, and the group of nodes 7 shifted down). However, as shown in FIG. 10, when using an embodiment of the present invention, no changes are made to the positions of existing nodes in the layout when changes are applied to the graph. The nodes remain in the same positions and levels. This is more desirable from the perspective of a user. The stability of the layout going from FIG. 9 to FIG. 10 (using an embodiment of the present invention) is better than the stability of the layout going from FIG. 7 to FIG. 8 (using the prior art process).

Note that in an embodiment of the present invention, nodes 3 and 5 are placed on two levels further (FIG. 9) than in a layout done with a prior art method (FIG. 7). This allows for a stable incremental step in an embodiment of the present invention (compare FIGS. 9 and 10—no old nodes are moved!). Without using information about hidden nodes at all, nodes 3 and 5 would be placed in a location similar to the prior art method and some node would be moved at the next incremental step. Thus, using information about hidden nodes according to embodiments of the present invention provide for avoiding both an ugly layout when a lot of nodes are hidden and the unnecessary moving of nodes when making incremental layouts.

While the embodiments of the present invention may be used for visualization of any graph, they are especially useful for visualizing large graphs having many nodes (e.g., thousands of nodes). In this case, only a small part of the nodes of the overall graph may be shown, while the remaining parts are initially hidden from view. The user can then reveal selected hidden parts that are of current interest. Such graph exploration by the user requires small changes in the graph, such as revealing a selected node or edge, hiding a selected node or edge, and so on. The stable incremental layout method of the embodiments of the present invention allows the user to perform these operations while ensuring the stability of the graph layout. This makes software tools employing such a method more useful for the user.

Although the operations described herein may be described as a sequential process, some of the operations may in fact be performed in parallel or concurrently. In addition, in some embodiments the order of the operations may be rearranged without departing from the spirit of the invention.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the scope of the invention.

What is claimed is:

1. A method of stable incremental layout of a hierarchical graph comprising:
determining a level of the layout for each new node of the graph using information about hidden nodes of the graph;
determining positions of nodes on levels of the layout using information about hidden nodes of the graph; and
determining coordinates of new nodes in the layout without using information about hidden nodes.

2. The method of claim 1, further comprising inserting new levels of the layout between existing levels when a new level is needed to contain a new node.

3. The method of claim 2, wherein nodes on existing levels retain positions on the existing levels.

4. The method of claim 1, wherein the determining steps are performed to minimize visual changes in the layout as compared to an initial layout of the graph.

5. The method of claim 1, further comprising complying with quality criteria.

6. The method of claim 1, wherein the quality criteria comprises minimization of edge crossings of the layout.

7. The method of claim 1, wherein the quality criteria comprises minimization of back edges of the layout.

8. An article comprising: a storage medium having a plurality of machine accessible instructions, wherein when the instructions are executed by a processor, the instructions provide for stable incremental layout of a hierarchical graph by determining a level of the layout for each new node of the graph using information about hidden nodes of the graph, determining positions of nodes on levels of the layout using information about hidden nodes of the graph, and determining coordinates of new nodes in the layout without using information about hidden nodes.

9. The article of claim 8, further comprising instructions to insert new levels of the layout between existing levels when a new level is needed to contain a new node.

10. The article of claim 9, wherein nodes on existing levels retain positions on the existing levels.

11. The article of claim 8, wherein the determining instructions are executed to minimize visual changes in the layout as compared to an initial layout of the graph.

12. The article of claim 8, further comprising complying with quality criteria.

13. The article of claim 8, wherein the quality criteria comprises minimization of edge crossings of the layout.

14. The article of claim 8, wherein the quality criteria comprises minimization of back edges of the layout.

15. A method of stable incremental layout of a hierarchical graph having nodes and edges comprising:
generating an initial layout of the graph; and
generating, as a result of a change in the graph, an incremental layout of the graph based on the initial layout by performing
for each new node of the graph, determining a level of the incremental layout using information about hidden nodes of the graph, and inserting a new level in the incremental layout between existing levels when the new level is needed to contain the new node;
for each level, determining positions of new nodes on each level of the incremental layout using information about hidden nodes of the graph; and
for each level, determining coordinates of new nodes in the incremental layout without using information about hidden nodes.

16. The method of claim 15, wherein nodes on existing levels retain positions on the existing levels.

17. The method of claim 15, wherein the determining steps are performed to minimize visual changes in the incremental layout as compared to an initial layout of the graph.

18. The method of claim 15, further comprising complying with quality criteria, wherein the quality criteria comprises at least one of minimization of edge crossings, and minimization of back edges.

19. An article comprising: a storage medium having a plurality of machine accessible instructions, wherein when the instructions are executed by a processor, the instructions provide for stable incremental layout of a hierarchical graph by
generating an initial layout of the graph; and
generating, as a result of a change in the graph, an incremental layout of the graph based on the initial layout by performing
for each new node of the graph, determining a level of the incremental layout using information about hidden nodes of the graph, and inserting a new level in the incremental layout between existing levels when the new level is needed to contain the new node;
for each level, determining positions of new nodes on each level of the incremental layout using information about hidden nodes of the graph; and
for each level, determining coordinates of new nodes in the incremental layout without using information about hidden nodes.

20. The article of claim 19, wherein the determining instructions are executed to minimize visual changes in the incremental layout as compared to an initial layout of the graph.

21. The article of claim 19, further comprising complying with quality criteria, wherein the quality criteria comprises at least one of minimization of edge crossings, and minimization of back edges.
